(19) United States
(12) Patent Application Publication
(10) Pub. No.: US 2004/0264065 A1
(43) Pub. Date: Dec. 30, 2004

(54) Non-linear shunt protective device for ESD protection

(76) Inventors: Stefan A. Ionescu, Burnsville, MN (US); Zhe Shen, St Paul, MN (US)

Correspondence Address: Seagate Technology LLC, 1280 Disc Drive, Shakopee, MN, 55379, US

(21) Appl. No.: 10/761,474

(22) Filed: Jan. 21, 2004

Related U.S. Application Data
(60) Provisional application No. 60/483,031, filed on Jun. 27, 2003.

(51) Int. Cl. G11B 5/39

(52) U.S. Cl. 360/323

(57) ABSTRACT

A circuit includes an element that can damaged by a potential over 400 mV. The element conducts with an element conductance over an element operating voltage range under 400 mV at element leads. The circuit also includes a shunt protective device connected to at least one of the element leads. The shunt protective device conducts with a shunt conductance above 400 mV that is greater than the element conductance. The shunt protective device conducts with a shunt conductance over the element operating voltage range that is less than the element conductance.

### CROSS-REFERENCE TO RELATED APPLICATION

This application claims the benefit of U.S. Provisional Application 60/483,031 filed on Jun. 27, 2003 for inventors Stefan Ionescu and Zhe Shen and entitled “Method for Improving The ESD Robustness Of the Head Stack Assembly.”

### FIELD OF THE INVENTION

The present invention relates generally to electrostatic discharge (ESD) protection, and more particularly but not by limitation to protection of magnetoresistive transducers from electrostatic discharge.

### BACKGROUND OF THE INVENTION

As the areal density and speed of disc drives increase, magnetoresistive read transducers are being correspondingly reduced in size and are more sensitive to damage from extremely low levels of electrostatic discharge (ESD). In particular, new designs that include spin tunneling junction magnetoresistive read transducers (STJMR) are more sensitive to ESD damage than the older spin valve magnetoresistive devices. The STJMR read transducers, which operate at voltages of less than 400 millivolts, can be damaged by electrostatic discharges of 5 volts or less, and are thus subject to damage during handling and manufacturing, even when extensive static suppression techniques are practiced in a modern disc drive manufacturing environment.

Electronic integrated circuits, especially those used in read channels in disc drives, include narrower integrated circuit line widths and increasingly lower operating voltage ranges and are correspondingly more sensitive to electrostatic discharge damage.

A method and apparatus are needed that will protect STJMR read transducers, as well as other transducers and circuits with low operating voltage ranges, from damage due to electrostatic discharges. Embodiments of the present invention provide solutions to these and other problems, and offer other advantages over the prior art.

### SUMMARY OF THE INVENTION

Disclosed is a circuit comprising an element having a susceptibility to damage from a potential over 400 millivolts. The element conducts with an element conductance over an element operating voltage range under 400 millivolts at element leads.

The circuit also comprises a shunt protective device connected to at least one of the element leads. The shunt protective device conducts with a shunt conductance above 400 millivolts that is greater than the element conductance. The shunt protective device conducts over the element operating voltage range with a shunt conductance less than the element conductance.

Other features and benefits that characterize embodiments of the present invention will be apparent upon reading the following detailed description and review of the associated drawings.

### BRIEF DESCRIPTION OF THE DRAWINGS

FIG. 1 illustrates an oblique view of a disc drive.

FIG. 2 illustrates a side cross sectional view of a read/write head with a magnetoresistive transducer.

FIG. 3 illustrates a front cross sectional view of a magnetoresistive transducer.

FIG. 4 illustrates a diagram of a manufacturing environment for manufacturing head stack assemblies.

FIG. 5 illustrates PRIOR ART arrangements of PN diodes.

FIG. 6 illustrates a schematic diagram of a test arrangement for testing effectiveness of a shunt protective device.

FIG. 7 illustrates schematic diagrams of connections of shunt protective devices.

FIG. 8 illustrate a graph of conductance as a function of applied voltage to a shunt protective device with non-linear conductance.

FIG. 9 illustrates exemplary locations where a shunt protective device can be physically located to protect various elements in a read channel.

FIG. 10 illustrates a graph of voltages as a function of time for electrostatic discharge tests on a non-linear shunt protective device.

FIG. 11 illustrates a graph of voltage as a function of time for electrostatic discharge tests on a silicon PN diode and a non-linear shunt protective device.

FIGS. 12, 13 schematically illustrates examples of shunt protective devices.

### DETAILED DESCRIPTION OF ILLUSTRATIVE EMBODIMENTS

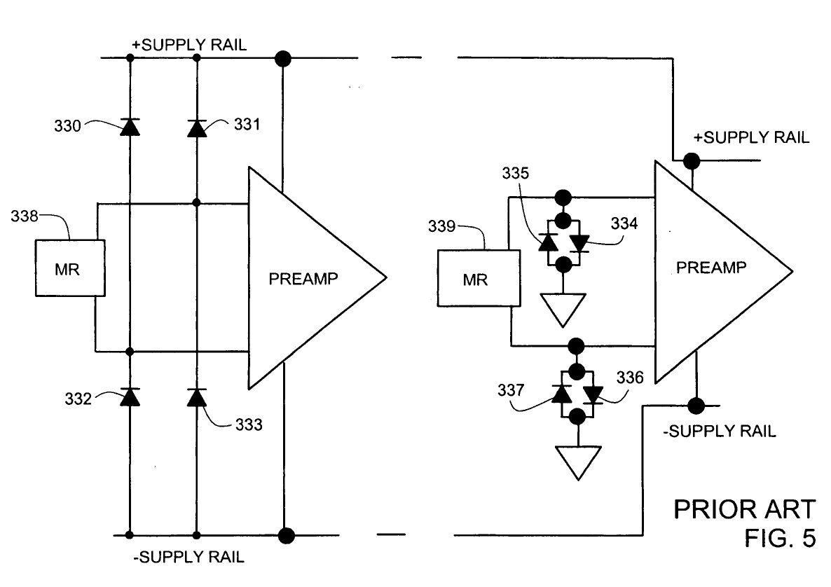

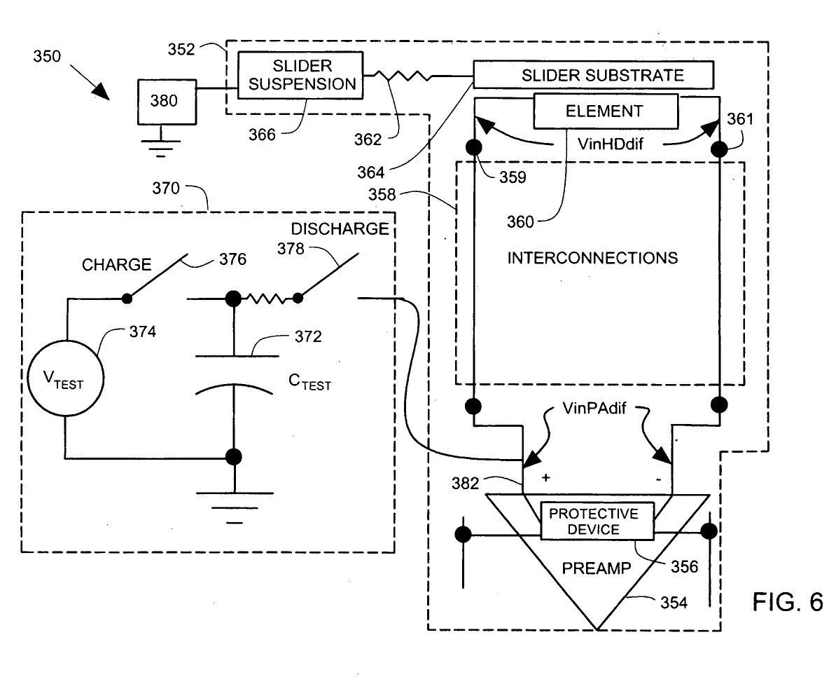

Disc drive designs with Spin Tunneling Junction Magnetoresistive read transducers (STJMR) are more sensitive to ESD damage than the older Spin Valve (SV) technology. For some process steps in a drive manufacturing environment, power for a preamplifier connected to the magnetoresistive transducer is not yet connected. Protection of the older magnetoresistive transducers was achieved through silicon PN diodes provided at the reader input of the preamplifier in various configurations (FIG. 5). Due to the fact that the STJMR threshold for damage is smaller than the forward voltage across a typical silicon PN junction, the existing arrangement with PN diodes does not protect the new STJMR transducers. In the embodiments described below in connection with FIGS. 6-13, STJMR and other extremely sensitive devices are protected with a shunt protective device that conducts with a shunt conductance greater than the element conductance above 400 millivolts, and conducts with a shunt conductance less than the element conductance over the element operating voltage range. Shunt protective devices such as Schottky diodes, Junction Barrier Schottky diodes, Trench MOS Schottky Barrier diodes, and static induction diodes and transistors can be used, provided that such devices are manufactured to be compatible with the high frequency data rates and manufactured to be in a high conductance state at 400 millivolts and above.

Read transducers, particularly STJMR elements as well as read preamplifiers, and particularly read preamplifiers using static induction transistors, are elements that can be protected with shunt protective devices, resulting in better trade offs between power supply voltages and circuit performance.

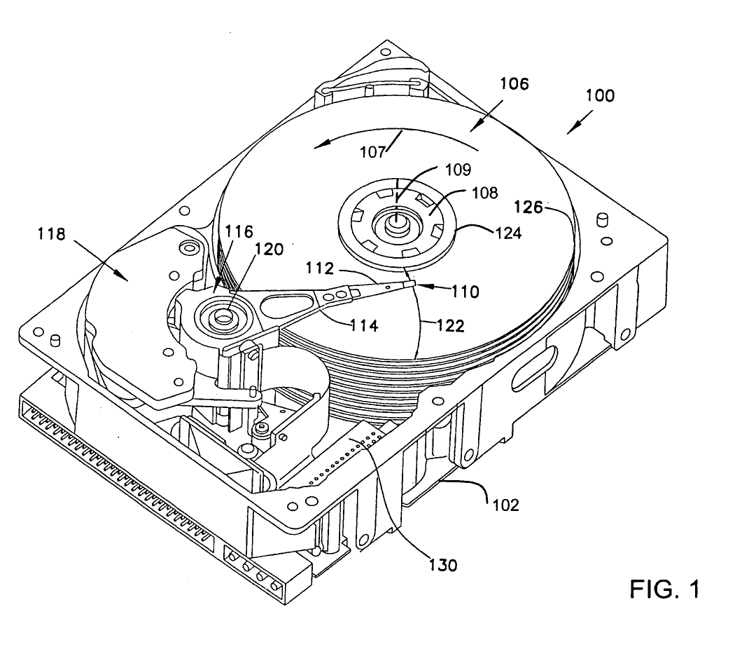

FIG. 1 illustrates an oblique view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes a plurality of individual discs, which are mounted for co-rotation in a direction indicated by arrow 107 about central axis 109. Each disc surface has an associated disc read/write head slider 110 which is mounted to disc drive 100 for communication with the disc surface. In the example shown in FIG. 1, sliders 110 are supported by suspensions 112 which are in turn attached to track accessing arms 114 of an actuator 116. Each disc read/write slider 110 includes one or more read transducers (not illustrated in FIG. 1) which are subject to damage from electrostatic discharge during handling. The actuator shown in FIG. 1 is of the type known as a rotary moving coil actuator and includes a voice coil motor (VCM), shown generally at 118. Voice coil motor 118 rotates actuator 116 with its attached read/write heads 110 about a pivot shaft 120 to position read/write heads 110 over a desired data track along an arcuate path 122 between a disc inner diameter 124 and a disc outer diameter 126. Voice coil motor 118 is driven by electronics 130 based on signals generated by read/write heads 110 and a host computer (not shown).

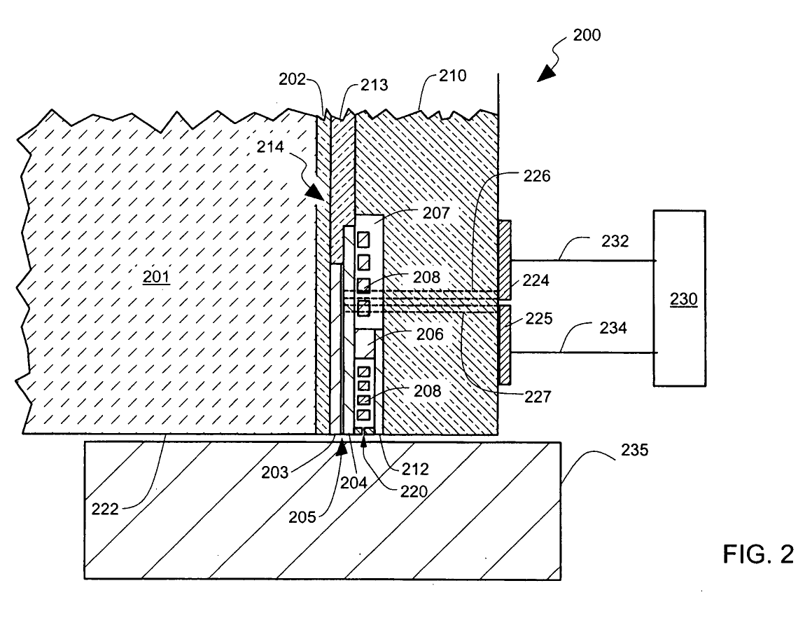

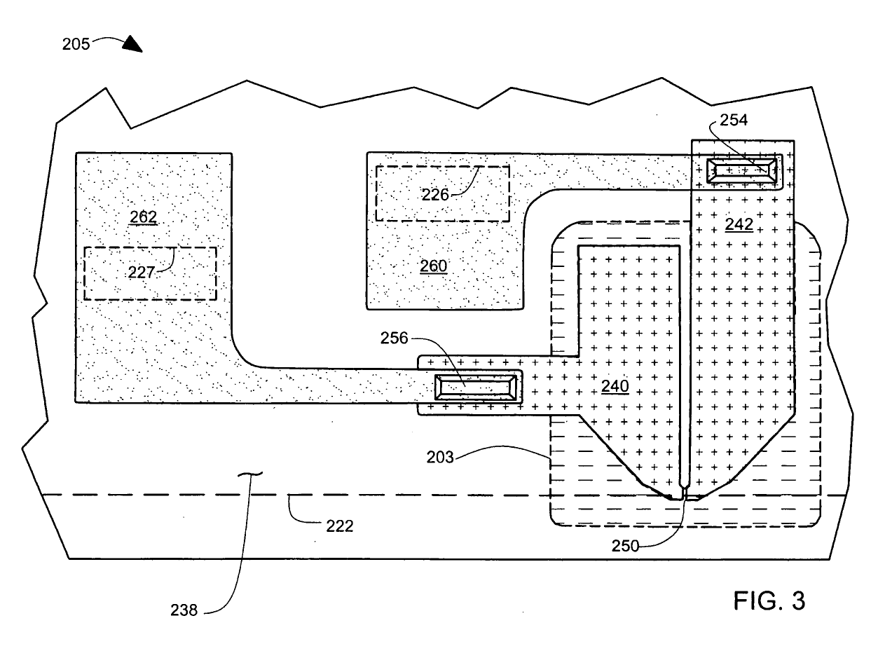

FIG. 2 illustrates a read/write slider 200 which includes a read/write head 214 formed on a substrate 201. Head 214 is typically formed using thin film processing techniques. The read/write head 214 includes a first insulating layer 202 and a second insulating layer 213 that are typically formed of aluminum oxide Al₂O₃. A first magnetic shield 203 also called a lower shield is deposited on the first insulating layer 202. A series of read transducer layers 205 are then deposited on the lower shield 203. The read transducer 205 is illustrated in more detail below in FIG. 3. A second magnetic shield 204 also called an upper shield or shared pole is deposited over layers of read transducer 205, which include reader insulating layers for electrical isolation from magnetic shields 203, 204. A write coil 208 is deposited over the shared pole 204 and surrounded by a write coil insulator layer 207, which is typically an organic material. A magnetic core 206 goes through the center of the write coil 208. A write magnetic layer 212 is then deposited over the magnetic core 206. A write gap 220 is formed between the shared pole 204 and the write magnetic layer 212.

In the read/write head 214, a lapped surfaced 222 exposes the read transducer 205 and the write gap 220 for reading and writing data on a disc 235. The read transducer 205 is connected by way of electrical vias 226, 227 to bonding pads 224 and 225 formed at an external surface of a topping layer 210. Bonding pads 224, 225 are connected by external leads 232, 234 to a read channel 230. Topping layer 210 is also typically aluminum oxide.

FIG. 3 schematically illustrates the read transducer 205 in more detail. Reference numbers used in FIG. 3 that are the same as reference numbers used in FIG. 2 identify the same features. An electrically insulating layer 238 is deposited over the lower shield 203. A magnetoresistor 250, which includes multiple layers, is deposited on the electrically insulating layer 238. Transducer contact layers 240, 242 are deposited to make electrical contact with the magnetoresistor 250. The transducer contact layers 240, 242 are formed of an electrically conducting metallization. The internal connection 240 is connected by a via 256 to a bond pad 262. The bond pad 262 connects by way of bond pad via 227 to the first bonding pad 225 (FIG. 2), which is external to the read/write head 214. The transducer contact layer 242 is connected through a via 254 to a bonding pad 260. Bonding pad 260 is connected by bonding pad via 226 to the external bonding pad 224 (FIG. 2). The magnetoresistor 250 is an element that is susceptible to damage from electrostatic discharges. The arrangement illustrated in FIGS. 2-3 is merely exemplary, and it will be understood by those skilled in the art that a wide variety of elements can be susceptible to damage from electrostatic discharges.

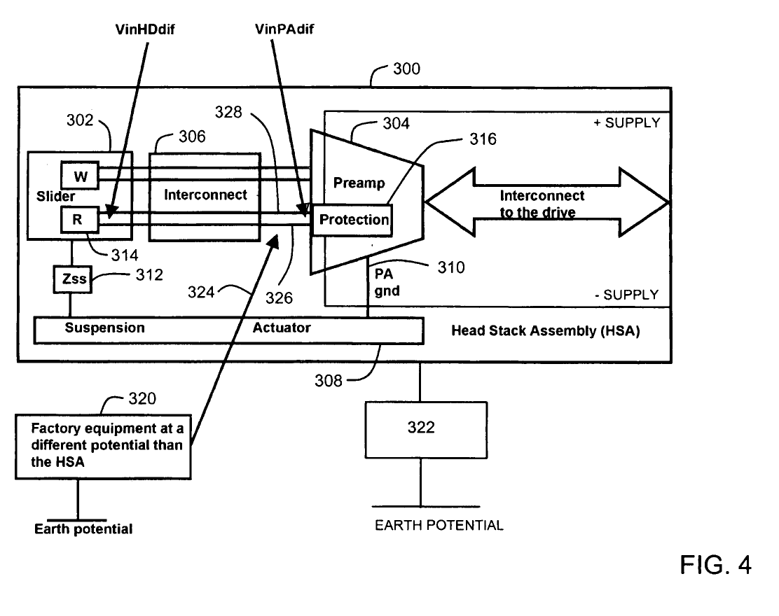

FIG. 4 illustrates a diagram of a manufacturing environment for manufacturing head stack assemblies. In FIG. 4, a head stack assembly (HSA) 300 includes a read/write head 302 coupled to a preamplifier circuit 304 by interconnecting leads 306. The head stack assembly 300 is a subassemby that is handled at various steps prior to its installation in a disc drive such as the one illustrated in FIG. 1. At each point where the head stack assembly 300 is handled and becomes an electrical bridge between various work surfaces and human or robotic handlers, there is a possibility of small electrostatic discharges through circuitry on the head stack assembly 300. If these discharges are large enough in relation to damage thresholds of circuit components, then electrostatic damage can occur.

The preamplifier circuit 304 is grounded to a suspension actuator 308 by a ground connection 310. The read/write head 302 is also grounded to the suspension 308 by an impedance (Zss) 312 that is on the order of 100 ohms to 100 megohms resistance, and typically 10K ohms. It will be understood by those skilled in the art that this “grounding” has no actual fixed connection to the earth when the head stack assembly 300 is a loose component being handled in the manufacturing environment.

The read/write head 302 includes a magnetoresistive read transducer (R) 314 that is susceptible to damage from electrostatic discharge. The preamplifier 304 includes a protection circuit 316 that typically includes one or more silicon PN diodes that are shunted across interconnect leads to absorb energy from electrostatic discharge and protect the read transducer 314. Factory equipment 320 is charged to an electric potential (relative to an earth potential) that can be different than the electric potential of the suspension actuator. Charging can occur by friction electrification, movement of air currents, or coupling from other nearby electrified objects. There is also a ground impedance 322 connecting the head stack assembly 300 to the earth potential. The factory equipment 320 is typically a robotic arm and the ground impedance 322 is typically the impedance to ground of a work surface upon which the head stack assembly is resting when the robotic arm picks it up. The head stack assembly 300 becomes a path for undesired electrostatic discharge between the robotic arm and the work surface. Discharge paths through the head stack assembly can be complex and unpredictable, depending on the points of contact.

When the factory equipment 320 connects along line 324 to a lead 326 that is connected to the read transducer 314, an electrostatic charge is discharged through protection circuitry 316 associated with the read transducer 314. The protection circuit 316 carries a large portion of the charge, however, the voltage on lead 326 is momentarily increased relative to a second interconnect lead 328. A first differential voltage VinPAdif is present between the leads 326, 328 at the preamplifier 304. The interconnect circuit 306 comprises a transmission line between the preamplifier 304 and the read transducer 314. A second differential voltage VinHDdif is present at the read transducer 314. With existing read transducers, an arrangement of silicon PN diodes in the protection circuit 316 is adequate to keep VinHDdif low enough to limit damage to the read transducer 314. Various arrangements of the protective circuit 316 are described below in connection with FIG. 5. However, with the reduction in size of read transducers, and particularly with the use of spin tunneling junction magnetoresistive read transducers, silicon PN diodes are not adequate to provide protection. As described below in connection with FIGS. 6-13, a different arrangement provides adequate protection for more sensitive elements that cannot be adequately protected with PN junctions.

FIG. 5 illustrates two PRIOR ART arrangements of PN diodes 330-337 to provide protection for older spin valve magnetoresistive devices 338, 339. PN diodes 330-337 have a forward drop of about 700 millivolts, which is an adequate protection level for the older spin valve magnetoresistive devices 338, 339. The forward drop of the PN diodes 330-337, however, is too high to provide adequate protection for STJMR read transducers. It will be understood by those skilled in the art that the + supply rail and the − supply rail and the DC common rail illustrated in FIG. 5 are connected together by large capacitors (not illustrated) such that the + supply rail, the − supply rail and the DC common supply rail are effectively shorted together with an AC short circuit through the large capacitors. The voltage across the magnetoresistors 338, 339 can thus rise up to a PN diode voltage drop of about 700 millivolts during electrostatic discharges. Discharges of 700 millivolts are above a damage threshold for STJMR devices, and the arrangement shown in FIG. 5 is not adequate to protect STJMR devices.

FIG. 6 illustrates a schematic diagram of a test arrangement 350 for testing effectiveness of a shunt protective device on a head stack assembly circuit 352. The head stack assembly circuit 352 includes a preamplifier 354 that includes a protective device 356. The parameters of the protective device 356 are adjustable for comparing performance of existing protective devices such as silicon PN diodes with protective devices described in detail below. An interconnection 358 is provided that models the resistive, inductive and capacitive parameters of a flexible circuit in a head stack assembly. A magnetoresistive read element 360 is provided that includes a resistance that is typically 100 ohms (i.e., a conductance of typically 0.01 Siemens). A resistor 362 (typically 10K ohm) is included to represent a grounding connection between a slider substrate 364 and a slider suspension 366. A network 380 is provided to simulate a complex ground impedance comparable to the ground impedance 322 in FIG. 4.

Electrostatic discharge is simulated in a repeatable way by providing a test circuit 370 that is comparable to the factory equipment 320 in FIG. 4. The test circuit 370 comprises a capacitor (Ctest) 372 that is charged to potential (Vtest) 374 when a charge switch 376 is closed. After the capacitor 372 is charged, then charge switch 376 is opened and discharge switch 378 is closed to simulate a discharge of the capacitor 372 into a selected portion of the head stack assembly 352. The test circuit 370 repeatably simulates an electrostatic discharge from a manufacturing environment, for example, discharge from factory equipment 320 (FIG. 4). In the example illustrated, the simulated discharge is applied between the earth reference for equipment and a positive (non-inverting) input 382 of the preamplifier 354. The simulated discharge returns to the earth reference by way of the network 380. The potential Vtest can be varied to precise levels such as 1 volt, 2 volt, 3 volt, 4 volt, 5 volt to provide repeatable results at varying levels of discharge. The capacitance Ctest can also be set to values such as 50 picofarad or 100 picofarad to vary parameters of the simulated test.

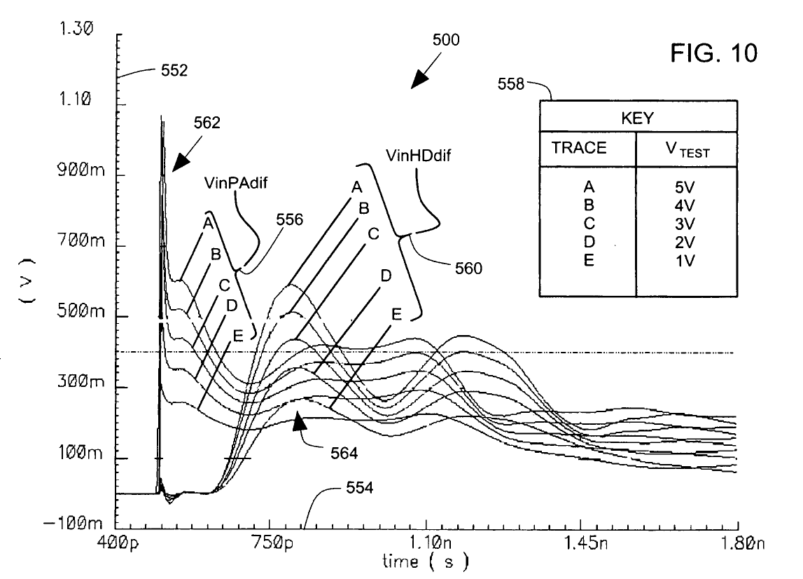

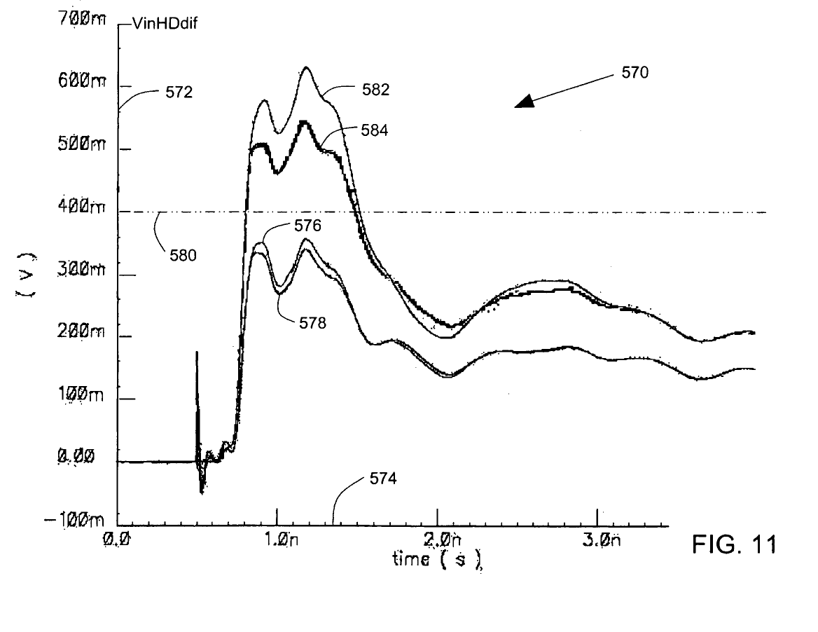

The simulation 350 provides data output that include voltages VinPAdif across inputs of the preamplifier 354 and VinHDdif across the element 360. VinPAdif typically differs from VinHDdif due to wave propagation and reflection in the interconnect 358. VinPAdif and VinHDdif outputs are useful in evaluating the effectiveness of the protective device 356 as a function of the parameters selected for the protective device 356, and provides data that guides the designer's search for devices that will protect extremely sensitive elements 360. Exemplary test results are describe below in connection with FIGS. 10-11.

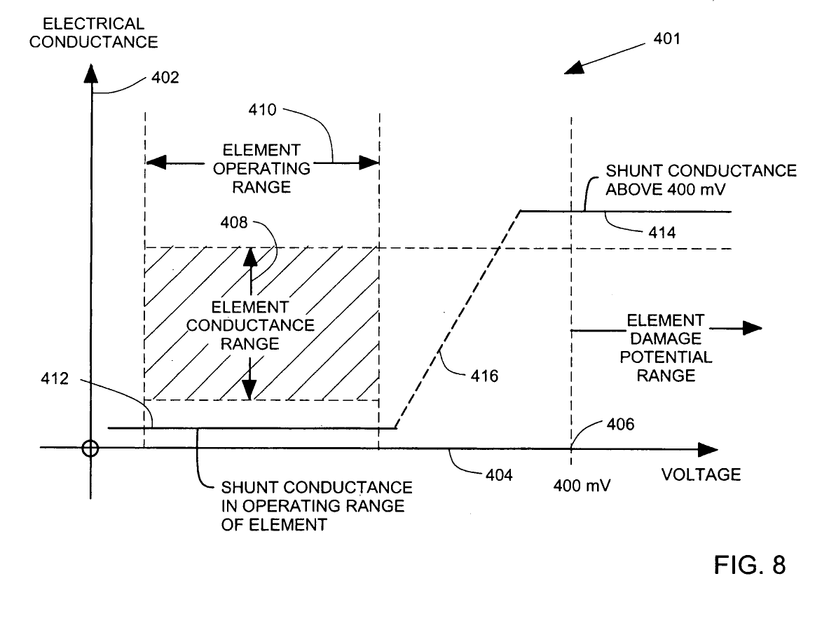

In FIG. 6, the circuit 352 simulates a head stack assembly and comprises the element 360 that has a susceptibility to damage from a potential over 400 millivolts. The element 360 conducts with an element conductance (408 in FIG. 8) over an element operating voltage range (410 in FIG. 8) under 400 millivolts at element leads 359, 361.

The circuit also comprises a shunt protective device (or network of shunt protective devices) 356 connected to the element leads 359, 361. Above 400 millivolts, the shunt protective device 356 conducts with a shunt conductance (414 in FIG. 8) above 400 millivolts that is greater than the element conductance (408 in FIG. 8). Over the element operating voltage range (410 in FIG. 8), the shunt protective device 356 conducts with a shunt conductance (412 in FIG. 8) that is less than the element conductance (408 in FIG. 8). Shunt conductive device 356 preferably comprises a passive, non-linear device to provide different levels of conductance at different voltages.

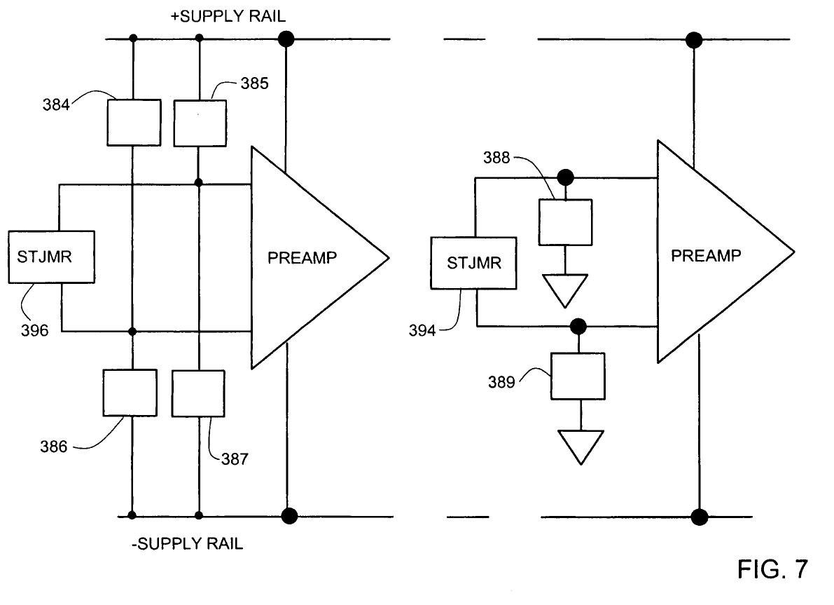

FIG. 7 illustrates schematic diagrams of two examples of connections of shunt protective devices connected to protect STJMR devices 394, 396. The arrangements shown in FIG. 7 are not energized and thus the + power supply, the − power supply and the DC common rails are all essentially at the same DC voltage and are coupled together by large capacitances (not shown) that effectively provide low impedance AC short circuits between the rails. The shunt protective devices 384, 385, 386, 387, 388, 389 conduct at 400 millivolts and above and thus limit voltages on STJMR devices 394, 396 to under 400 millivolts during electrostatic discharge events. The two examples illustrated in FIG. 7 can also be combined to protect a single STJMR device.

FIG. 8 illustrate a graph 401 of conductance as a function of applied voltage to a protected element. A vertical axis 402 represents electrical conductance, and a horizontal axis 404 represents voltage. A point 406 on the horizontal axis 404 indicates a voltage level of 400 millivolts. For an element that is sensitive to electrostatic discharge, it is desired to keep the voltage across the element to a level near about 400 millivolts in order to avoid damage from electrostatic discharge. An operating region for the element is identified by an area filled by diagonal lines and includes an element conductance range 408 and an element operating voltage range 410. In the present arrangement, protection for the element is provided by a non-linear shunt protective device that has a first conductance level 412 that is lower than the element conductance range 408 throughout the element voltage operating range 410. The first conductance level 412 is low enough so that the shunt protective device does not excessively load voltage signals generated across the element. The shunt protective device has a second conductance level 414 at 400 millivolts and above that is higher than the element conductance range 408. The second conductance level 414 of the shunt protective device effectively loads electrostatic discharges with a high conductance (low impedance) so that the voltage across the element is kept in the range of 400 millivolts or less. There is preferably an abrupt transition 416 between levels 412, 414. The shunt protective device preferably has a low capacitance to provide high frequency operation compatible with high data rates. It will be understood by those skilled in the art that the element conductance range represents the range of a single protective element connected directly across the protected device, and that equivalent impedances can be achieved by more complex shunt arrangements such as those described above in connection with FIG. 7.

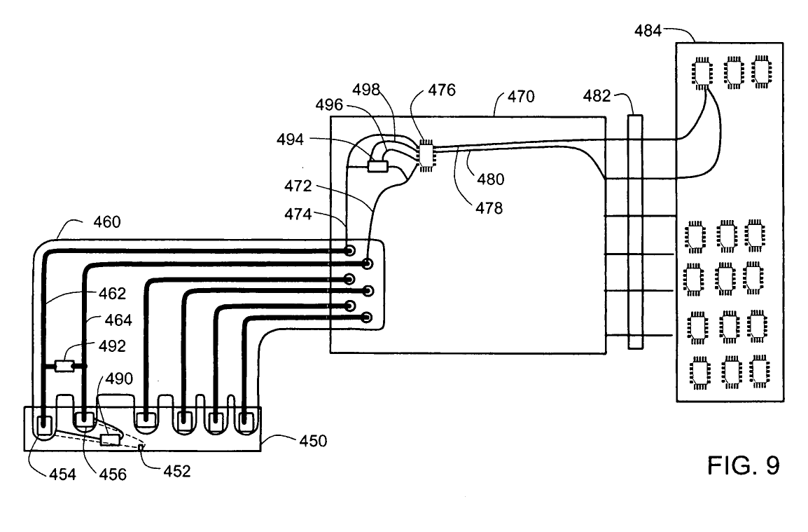

FIG. 9 schematically illustrates exemplary locations where a shunt protective device (or a network of multiple shunt protective devices) can be physically located to protect read elements in a read channel. In FIG. 9, a read/write head 450 includes a magnetoresistive read transducer 452 that is connected to contact pads 454, 456 on the read/write head 450. A first flexible printed circuit 460 is mounted to a track accessing arm (such as track accessing arm 114 of FIG. 1) and includes conductors 462, 464 that are connected to the contact pads 454, 456. A second flexible printed circuit 470 is mounted on a hub of an actuator (such as actuator 116 of FIG. 1) and includes conductors 472, 474 that connect to conductors 462, 464. The second flexible printed circuit 460 also includes a read channel preamplifier 476. Read channel preamplifier 476 is typically a multiple channel preamplifier and connects to multiple read/write heads (only one of which illustrated in FIG. 9). An output of the preamplifier 476 is coupled out on conductors 478, 480 to a feedthrough connector 482 that separates a sealed disc drive compartment from a surrounding atmosphere. Connector 482 connects to a printed circuit board 484 that includes a large number of integrated circuits that support disc drive operation. Shunt protective devices can be positioned to protect the magnetoresistive transducer 452 at one or more locations such as location 490 on the read/write head 450, the location 492 on the first flexible printed circuit 460, and location 494 on the second flexible printed circuit 470. Depending on the needs of the application, multiple shunt protective devices can be used that are connected to one or more supply conductors (supply rails) 496, 498.

FIG. 10 illustrates a graph 500 of voltage as a function of time for simulated electrostatic discharge tests on a passive non-linear shunt protective device. In FIG. 10, a vertical axis 552 represents voltage in millivolts and volts and a horizontal axis 554 represents time in picoseconds and nanoseconds. The data indicated in FIG. 10 represents a simulation of a device such as the one illustrated in FIG. 8 used as a shunt protective device (such as shunt protective device 356 of FIG. 6) in the test simulation shown in FIG. 6. A first family of curves 556 represents voltages VinPAdif (at the protection device 356 in FIG. 6 with the voltage Vtest (FIG. 9) set to different levels as indicated by key 558. A second family of curves 560 represents voltages VinHDdif (at the magnetoresistive transducer element 360 in FIG. 6) with the voltage Vtest (FIG. 9) set to different levels as indicated by the key 558. It can be seen by inspection of the graph 500 that large peaks 562 present at VinPAdif are effectively absorbed by the shunt protective device 356 (FIG. 6) and much lower peaks 564 of the curves 560 are present at VinHDdif at the magnetoresistive element 360 (FIG. 6).

FIG. 11 illustrates a graph 570 of a simulation test of voltage as a function of time for electrostatic discharge tests on a Schottky diode as a shunt protective device in the arrangement illustrated in FIG. 6 in comparison to results for a silicon PN diode. In FIG. 11, a vertical axis 572 represents the voltage VinHDdif in millivolts and a horizontal axis 574 represents time in nanoseconds. A first trace 576 shows results for a Schottky diode when a fixed ON (high conductance) voltage model is used and a second trace 578 shows results for a Schottky diode when a variable ON (high conductance) voltage model is used for the Schottky diode. It can be seen by inspection of graph 570 that peaks of the voltages 576, 578 for the Schottky diode stay below a failure level 580 at 400 millivolts. Corresponding results for a silicon PN diode shown at traces 582, 584 exceed the failure level 580. Damage is avoided by using the Schottky diode as a shunt protective device, whereas damage occur when a silicon PN diode is used as a protective device.

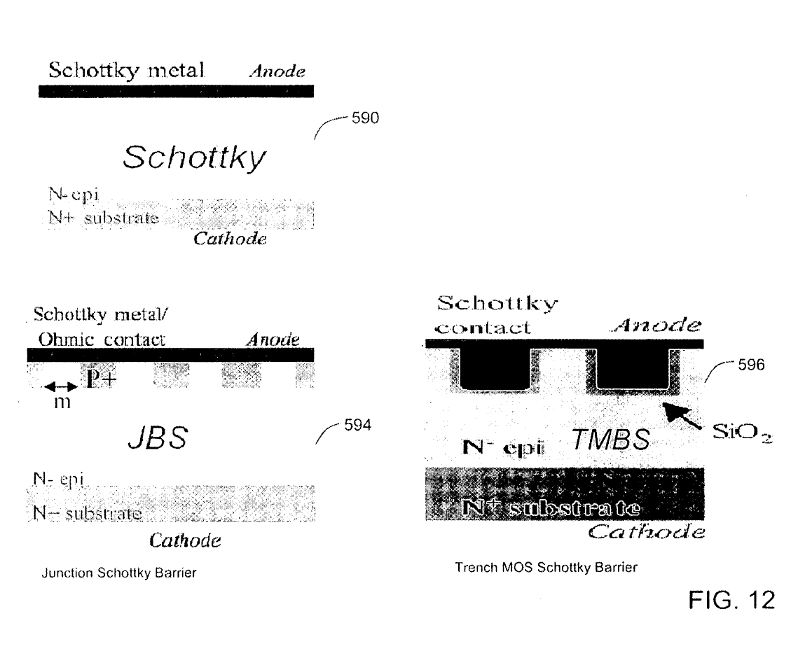

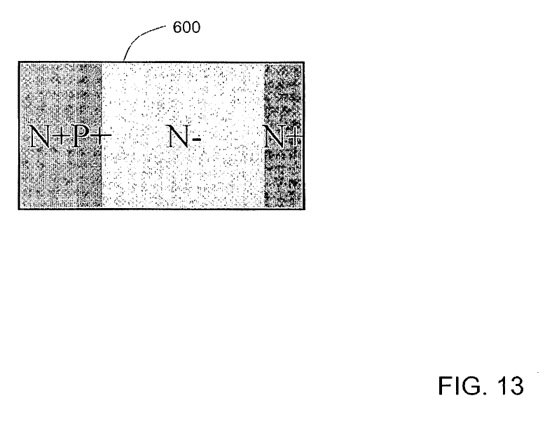

FIGS. 12, 13 schematically illustrates shunt protective devices. When semiconductor processing parameters are adjusted to provide the desired conductance at a voltage of 0.400 volt or less, semiconductor devices such as Schottky diode 590, Junction Schottky Barrier diode 594, trench MOS Schottky Barrier diode 596 and static induction diode 600 can be effectively used as shunt protection devices when semiconductor processing parameters are used that provide the desired high conductance characteristic at 400 millivolts and above. Multiple shunt protective devices can be arranged in various series or parallel arrangements to provide protection for both polarities of electrostatic discharges as illustrated above in connection with FIG. 7. The shunt protective device used, such as static induction diode 600 is preferably specially processes to have a die size that is small and compatible with the high data rates generated by the magnetoresistive head.

In summary, a circuit (such as 352) comprises an element (such as 360) having a susceptibility to damage from a potential over 400 millivolts. The element conducts with an element conductance (such as 408) over an element operating voltage range (such as 410) under 400 millivolts at element leads (such as 359, 361).

The circuit also comprises a shunt protective device (such as 356) connected to at least one of the element leads. Above 400 millivolts, the shunt protective device conducts with a shunt conductance (such as 414) greater than the element conductance above 400 millivolts. Over the element operating voltage range, the shunt protective device conducts with a shunt conductance (such as 412) that is less than the element conductance.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the electrostatic protection system while maintaining substantially the same functionality without departing from the scope and spirit of the present invention. In addition, although the preferred embodiment described herein is directed to a data storage system for a computer, it will be appreciated by those skilled in the art that the teachings of the present invention can be applied to static sensitive devices in other electronic equipment, without departing from the scope and spirit of the present invention.

What is claimed is:

1. A circuit, comprising:
an element having a susceptibility to damage from a potential over 400 millivolts, and conducting with an element conductance over an element operating voltage range under 400 millivolts at element leads; and
a shunt protective device connected to at least one element lead, the shunt protective device conducting with a shunt conductance above 400 millivolts that is greater than the element conductance, and conducting with a shunt conductance over the element operating voltage range that is less than the element conductance.

2. The circuit of claim 1, further comprising:
an electronic circuit coupled to the element leads, the electronic circuit communicating a signal potential in the element operating voltage range.

3. The circuit of claim 1 wherein the shunt protective device comprises a passive electrical device.

4. The circuit of claim 3 wherein the shunt protective device comprises a static induction device.

5. The circuit of claim 3 wherein the shunt protective device comprises a Schottky diode.

6. The circuit of claim 3 wherein the shunt protective device comprises a Junction Schottky Barrier diode.

7. The circuit of claim 3 wherein the shunt protective device comprises a Trench MOS Schottky Barrier diode.

8. The circuit of claim 1 wherein the element comprises a magnetoresistive transducer.

9. The circuit of claim 8 wherein the magnetoresistive transducer comprises a spin tunneling junction magnetoresistive transducer.

10. The circuit of claim 1 wherein the element comprises a preamplifier.

11. The circuit of claim 1 wherein the element is located on a substrate.

12. The circuit of claim 11 wherein the shunt protective device is located on the substrate.

13. The transducer of claim 11 wherein the shunt protective device is located on the flexible circuit.

14. A circuit, comprising:
an element having a susceptibility to damage from a potential over 400 millivolts, and conducting with an element conductance over an element operating voltage range under 400 millivolts at element leads; and
means for protecting the element coupled to the element leads, the means conducting more than the element above 400 millivolts, and the means conducting less than the element over the element operating voltage range.

15. The circuit of claim 14 wherein the means comprises a static induction device.

16. The circuit of claim 14 wherein the means comprises a Schottky diode.

17. The circuit of claim 14 wherein the means comprises a Junction Schottky Barrier diode.

18. The circuit of claim 14 wherein the means comprises a Trench MOS Schottky Barrier diode.

19. The circuit of claim 14 wherein the element comprises a magnetoresistive transducer.

20. A method, comprising:
providing an element having a susceptibility to damage from a potential over 400 millivolts; and
providing a shunt protective device connected to the element that conducts at 400 rmllivolts and above.

21. The method of claim 20, comprising:
positioning the element on a slider substrate.

22. The method of claim 20, comprising:
positioning the shunt protective device on a flexible circuit.

23. The method of claim 20 wherein the shunt protective device comprises a static induction device.

24. The method of claim 20 wherein the shunt protective device comprises a Schottky diode.

25. The method of claim 20 wherein the shunt protective device comprises a Junction Schottky Barrier diode.

26. The method of claim 20 wherein the shunt protective device comprises a Trench MOS Schottky Barrier diode.
